(19) United States
(12) Patent Application Publication
(10) Pub. No.: US 2026/0045103 A1
(43) Pub. Date: Feb. 12, 2026

(54) METHOD FOR ASSIGNING DATA POINTS TO ONE OF SEVERAL OBJECTS

(71) Applicant: dSPACE GmbH, Paderborn (DE)

(72) Inventors: Simon ROMANSKI, Karlsruhe (DE); Fabian BOTH, Karlsruhe (DE); Harald HANSELMANN, Karlsruhe (DE); Yassine MARRAKCHI, Karlsruhe (DE); Oscar DARWIN, Karlsruhe (DE); Michael WEBER, Karlsruhe (DE)

(73) Assignee: dSPACE GmbH, Paderborn (DE)

(21) Appl. No.: 19/291,786

(22) Filed: Aug. 6, 2025

(30) Foreign Application Priority Data
Aug. 7, 2024 (EP) 24193318.3

(51) Int. Cl. G06V 20/64; G06V 10/764

(52) U.S. Cl. CPC G06V 20/64; G06V 10/764

(57) ABSTRACT

A computer-implemented method for assigning data points from first data to one of several objects, wherein the first data comprises at least three spatial dimensions. Groups of projected data points are formed and assigned to the respective objects, taking into account received information data from two-dimensional bounding polygons and from a bin of the data point by an assignment method such that for overlapping polygons in which projected data points are located within more than one two-dimensional bounding polygon, the groups are formed such that no bin is assigned to more than one of the overlapping polygons at the same time. A device is also provided for data processing to execute the method, and a computer program product, and a computer-readable medium on which the above computer program product is stored.

This nonprovisional application claims priority under 35 U.S.C. § 119 (a) to European Patent Application No. 24193318.3, which was filed on Aug. 7, 2024, and which is herein incorporated by reference.

### BACKGROUND OF THE INVENTION

### Field of the Invention

The invention relates to a computer-implemented method for assigning data points from first data to one of several objects at a time.

The invention also relates to a device for data processing, comprising means for carrying out the above method.

Further, the invention relates to a computer program product comprising commands which, when the program is executed by a computer, cause the computer to execute the above method.

Furthermore, the invention relates to a computer-readable medium on which the above computer program product is stored.

### DESCRIPTION OF THE BACKGROUND ART

Autonomous and semi-autonomous driving has the potential to change mobility and, for example, reduce travel times, energy consumption and/or emissions. As an important component for autonomous driving, 3D object recognition has received a lot of attention, and approaches to 3D object recognition based on machine learning have gained popularity in recent years.

In principle, existing approaches to 3D object recognition can be divided into two groups, depending on whether the first data is two-dimensional image data or three-dimensional point clouds, which are usually generated by lidar sensors. In methods based on image data captured by cameras, estimating the 3D envelope for an object from two-dimensional image data is a major challenge. However, due to the rapid development in the field of machine learning and especially in deep learning technologies, image-based 3D recognition has made remarkable progress.

One disadvantage of image-based 3D recognition using machine learning, however, is that a statistical algorithm has to be trained with a lot of learning data, which is time-consuming. In addition, 3D object recognition algorithms based on machine learning can also be very computationally intensive, which can make these methods inefficient. This is particularly problematic when large amounts of data have to be processed, as occurs in the field of data annotation. For example, annotated data may have a bounding box around a 3D object and/or have a label indicating that the 3D object is a vehicle. Annotated data is used, for example, when algorithms, such as neural networks, are to be trained with large data sets as part of supervised learning. The provision of annotated data has so far been associated with a great deal of partly manual effort, which is very time-consuming and costly.

### SUMMARY OF THE INVENTION

It is therefore an object of the present invention to enable 3D object recognition in a simple, fast, and/or cost-effective way.

Thus, according to an example of the invention, a computer-implemented method for assigning data points from first data to one of several objects is provided, wherein the first data comprise at least three spatial dimensions, with the steps of: receiving information data from two-dimensional bounding polygons, preferably from two-dimensional bounding rectangles, for the objects represented on second data, wherein the second data comprises at least two spatial dimensions, wherein the received information data defines a size and a position of the bounding polygon of the respective object in the second data; receiving a projection matrix, wherein the projection matrix defines a mapping of a three-dimensional data point from the first data to a two-dimensional data point in the second data; generating projected data points by projecting the three-dimensional data points of the first data using the received projection matrix; dividing the projected data points and/or the three-dimensional data points into bins based on a respective depth value of the three-dimensional data point; and forming groups of projected data points assigned to the respective objects taking into account the received information data of the two-dimensional bounding polygons and the bin of the data point by means of an assignment method in such a way that in the case of overlapping polygons where projected data points are located within more than one two-dimensional bounding polygon, the groups are formed in such a way that no bin is simultaneously assigned to several of the overlapping polygons.

In other words, the method of the invention is a method for forming clusters of data points of the first data, wherein the clusters are determined on the basis of the projection of the three-dimensional data in two spatial dimensions, taking into account the two-dimensional bounding polygons and the bin of the data points, preferably rectangles, of the second data. One aspect of the invention is in particular that each polygon is assigned a bin and in particular that the groups—i.e., the clusters—are not found individually for each polygon in overlapping polygons but are found by means of an overall view.

The method assigns the projected data points of the first data to the respective cluster, with each cluster representing an object. On the basis of the assignment, it is possible to determine a three-dimensional envelope, preferably a convex envelope, and particularly preferable a cuboid, for the object shown on the first data. The first data have at least three spatial dimensions, so that in principle the object can be visualized by plotting the first data in a three-dimensional grid. The respective values of a data point for the three spatial dimensions are also referred to as spatial coordinates (x, y, z).

In the first step of the method, the information data of the two-dimensional bounding polygon, and preferably of the two-dimensional bounding rectangle, are received. Preferably, the two-dimensional bounding rectangle is an axis aligned bounding box (AABB) of the object on the second data. The second data includes at least the two spatial dimensions. Thus, the object shown on the second data can be preferably visualized by plotting the second data in a two-dimensional grid. The respective values of a data point for the two spatial dimensions are also referred to as image coordinates (x, y).

The two-dimensional bounding polygons each completely enclose an object represented on the second data. In other words, for each object, there is no data point of the second data belonging to the object outside the respective polygon. The two-dimensional bounding polygon, and preferably the AABB, is defined by its information data, which specifies the size, especially the length of the two sides of the rectangle, and the position, especially preferably the image coordinates of a point, such as a vertex or the center of the rectangle, in the second data. In particular, in the case of several objects, it is possible that the two-dimensional bounding polygons overlap, or that one polygon is located completely within another polygon, for example if the objects shown on the second data are partially obscured. If, for example, the second data represents a convoy of vehicles, some areas of the rear of the vehicles at the beginning of the convoy are usually obscured by those vehicles that are directly behind these vehicles in terms of driving direction.

The first data and the second data can represent the same objects. Preferably, the first and second data represent the same objects at essentially the same time. The first data and the second data are therefore preferably correlated with each other in time. In the present case, at essentially the same time or correlated in time, preferably means that a recording time of the second data—i.e., those data that have at least two spatial dimensions—lies between a start recording time and an end recording time of the first data, i.e., those data that have at least three spatial dimensions.

In a further step of the method, the projection matrix is received. The projection matrix defines the mathematical mapping of a three-dimensional data point of the first data to a two-dimensional data point in the second data. By applying the projection matrix to the spatial coordinates, an image coordinate is generated.

In another step of the method, the projected data points are generated by projecting the three-dimensional data points of the first data using the received projection matrix. The projected data points are therefore two-dimensional data points.

In a further step of the method, the projected data points and/or the three-dimensional data points are divided into bins based on the respective depth value of the three-dimensional data points. In other words, the frequency distribution of the depth values of the original three-dimensional data points is preferably considered. Figuratively speaking, a histogram is formed by dividing the projected data points and/or the three-dimensional data points into the ‘bins.’

In the next step, the groups of projected data points are formed, taking into account the received information data from the two-dimensional bounding polygons and the bin of the data point—i.e., the frequency distribution of the depth values. This is done by means of the assignment method in such a way that in the case of overlapping polygons where projected data points are located within more than one two-dimensional bounding polygon, the groups are formed in such a way that no bin is assigned to more than one of the overlapping polygons at the same time. One aspect of the invention is therefore that each polygon is assigned a bin and in particular that in the case of overlapping polygons, this assignment is not found individually for each polygon, but instead a comprehensive overview is carried out.

In a situation where there are no overlapping polygons, it is preferably provided that the groups of projected data points are formed by taking into account the division of the projected data points and/or the three-dimensional data points into the bins for those projected data points that are located within a given polygon, in such a way that the respective polygon is assigned the bin, which has a maximum. In other words, for the projected data points that lie within the polygon, the frequency distribution of the depth values is considered, and the respective polygon is assigned the bin that has a maximum in the frequency distribution of the corresponding polygon.

For overlapping polygons, and therefore for projected data points that are located within more than one two-dimensional bounding polygon, the mapping method ensures that the groups are formed in such a way that no bin is assigned to more than one of the overlapping polygons at the same time. This is preferably done by first merging the overlapping polygons into a total polygon, more preferably by combining the overlapping polygons into the total polygon.

The groups of projected data points are then preferably formed by taking into account the division of the projected data points and/or the three-dimensional data points into the bins for those projected data points that are located within the total polygon in such a way that each individual polygon of the total polygon is assigned a bin at the same time, without a bin width being assigned to more than one of the overlapping polygons at the same time. Preferably, the assignment method therefore matches the available bins and the polygons. It is also preferable that this is a weighted assignment method in which the sum of the projected data points assigned to the individual polygons is maximized by assigning the bins to the polygons.

The method has the particular advantage that it is not computationally intensive and thus extremely resource-saving and efficient. This makes the method particularly suitable for processing large amounts of data quickly.

The first data can be a point cloud captured by means of a lidar or radar sensor. The first data is therefore preferably sparsely populated data, as the lidar or radar sensor only records a value at a few discrete spatial coordinates.

The second data can be image data captured by means of a camera. It is particularly preferable that the projection matrix is defined, among other things, by the orientation and position of the sensor used to record the first data in relation to the camera, as well as by the focal length of the camera.

In principle, it is possible that the received information data of the two-dimensional bounding polygon is generated by manual annotation of the image data captured by the camera. However, it is preferable that the image data captured by the camera is evaluated by machine learning and the two-dimensional polygon and preferably the AABB is determined that way. In this context, according to another preferred further development of the invention, it is provided that the step of receiving information data of the two-dimensional bounding polygon includes receiving information data of a two-dimensional minimum bounding polygon, and preferably of a two-dimensional minimum bounding rectangle, and scaling of the minimum bounding polygon by a factor greater than 1 and preferably less than or equal to 1.5, and/or that the step receiving information data of the two-dimensional bounding polygon includes receiving information data of a two-dimensional minimum bounding polygon scaled by a factor greater than 1 and preferably less than or equal to 1.5. The preferred factor is less than or equal to 1.3 and especially preferred less than or equal to 1.2.

The two-dimensional minimum bounding polygon can be an axis-parallel rectangle (AABB). The object can touch all four sides of the two-dimensional, minimum bounding rectangle. There is exactly one minimum AABB for a compact—i.e., self-contained and limited 2D object. This is the smallest possible axis-parallel rectangle that encloses the object. The minimum AABB can be determined, for example, by a minimum and maximum search using coordinates of all vertices of the object in the second data. It has been shown that the method yields better results if the minimum bounding polygon is slightly enlarged to account for certain inaccuracies, for example in the projection matrix, as projected data points that are slightly outside the minimum bounding polygon are then also taken into account.

In principle, it is possible that a bin width of the bin can be different for different bins. However, it is preferable that the step of dividing the projected data points and/or the three-dimensional data points into bins based on the respective depth value of the three-dimensional data point includes a division of the projected data points and/or the three-dimensional data points into bins with the same bin width. This makes the method particularly simple. It is also preferable that the bin width depends on the number of polygons in the second data—i.e., on the number of information data received by the two-dimensional bounding polygons. A small bin width is chosen for many polygons, and a large bin width for few polygons.

It is possible that the formation of groups of projected data points assigned to the respective objects may be done by means of a brute force procedure, in which all possible assignments of bins to polygons are tested. However, this is computationally intensive. According to a preferred further development of the invention, it is instead provided that the step of forming groups of projected data points assigned to the respective objects is carried out taking into account the received information data of the two-dimensional bounding polygons and the bin of the data point by means of the Hungarian method. The Hungarian method, also known as the Kuhn-Munkres algorithm, is an algorithm for solving weighted allocation problems that is very efficient.

The use of the Hungarian method has the further advantage that an optimal solution is reliably found. There are other methods that find an equivalent or almost equivalent solution without requiring significantly more computational effort. For example, dynamic programming or the Ford-Fulkerson algorithm can also be used to find a suitable assignment of points to the bins.

The step of forming groups of projected data points assigned to the respective objects taking into account the received information data of the two-dimensional bounding polygons and the bin of the data point can include forming groups in such a way that no projected data point is assigned to more than one group at the same time. In other words, the method is preferably strictly partitioning clustering or strictly partitioning clustering with outliers, wherein the data points of the first data or the projected data points cannot belong to more than one cluster.

As already mentioned, each polygon is assigned a bin. In this context, according to an example, it is provided that the method includes the step of assigning distance information, and preferably exactly one piece of distance information, to the respective groups formed. The assigned distance information can preferably be used to determine a three-dimensional envelope for the object shown on the first data.

It is possible that the assigned distance information can be the mean of the bin assigned to the polygon. For example, for a bin with a width of 5 m to 6 m, the assigned distance information would be 5.5 m. However, according to a preferred further development of the invention, it is provided that the step of assigning the distance information to the respectively formed groups includes forming a mean value over the respective depth values of the three-dimensional data points of the respective group assigned to the respective objects. In other words, the mean value of the depth values is formed using those three-dimensional data points that are assigned to the bin that has been assigned to the polygon. This mean value is then preferably assigned to the polygon as distance information.

In this context, the step of assigning the distance information to the respectively formed groups can comprise adding a prior knowledge term dependent on a classification result of the object, and the method preferably comprises the step of receiving a classification result of the object.

In relation to the first data, objects are only scanned by the sensor on surfaces that are aligned in the direction of the sensor due to their self-occlusion. In other words, data points from the object that are further away from the sensor are missing from the first data. If the distance information found on the basis of the described method is used for a center of gravity of a three-dimensional envelope, this can lead to a systematic error due to the lack of data points. To compensate for this error, it is preferable that the prior knowledge term be added to the distance information. In the first step of the method, therefore, preferably not only the information data of the bounding polygon is received, but also a classification result of the object covered by the polygon and represented on the second data.

The method can comprise the step of determining a three-dimensional envelope, preferably a cuboid, for the objects represented on the first data, taking into account the formed groups, preferably the assigned distance information, and the received information data of the two-dimensional bounding polygons.

The three-dimensional envelope can be defined by its size, position, and orientation of the envelope in the initial data. In the case of a cuboid, the size is preferably specified by the length of the three sides of the cuboid, the position is preferably specified by the spatial coordinates of a point, for example a vertex or the center of gravity of the cuboid, and the orientation, especially preferred by three angles, for example the roll-pitch-yaw angles. The distance information assigned to the group is particularly preferably used as a spatial coordinate for the position of the three-dimensional envelope. The other two spatial coordinates of the position of the three-dimensional envelope result preferably from the corresponding image coordinates of the polygon in the second data.

Furthermore, with regard to the size of the three-dimensional envelope, predefined size distributions dependent on the class of the object and especially Gaussian distributions of the size are preferred. For example, a first predefined size distribution is used for small cars and/or a second predefined size distribution is used for trucks. In principle, the size of objects, especially vehicles, can be described by Gaussian mixed models. A mixed model is a model for representing the presence of subpopulations within an overall population.

The step of determining the three-dimensional envelope for the objects represented on the first data, taking into account the formed groups and the received information data of the two-dimensional bounding polygons, can include a displacement and/or scaling of the three-dimensional envelope within a predefined limit in such a way that the formed groups are completely enclosed at three-dimensional data points by the three-dimensional envelope. In other words, by displacing and/or scaling the three-dimensional envelope, it can be achieved that as many data points of the first data assigned to a group as possible are located within the determined envelope. Preferably, local information from the first data—such as using a local point density of the first data to identify surfaces of the objects in the first data facing the sensor—and to use these to push the three-dimensional envelope as close as possible to these three-dimensional data points belonging to the surface.

The object of the invention is also achieved by a device for data processing comprising components, for example, a processor, memory, etc. for carrying out the method described above.

Further, the invention relates to a computer program product comprising commands which, when the program is executed by a computer, cause the computer to execute the above method.

Furthermore, according to the invention, a computer-readable medium, preferably a non-volatile computer-readable data medium, is provided on which the above computer program product is stored.

The technical advantages of the device for data processing, the computer program product and the computer-readable medium result for the skilled person from the description of the method for assigning data points from first data to one of several objects each, as well as from the examples described below.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows schematically projected data generated by a computer-implemented method for assigning data points from first data to one of several objects, according to an example of the invention,

FIG. 2 shows schematically, a histogram formed by the projected data shown in FIG. 1 in the method according to an example of the invention,

FIG. 3 shows schematically, two overlapping polygons, which in the computer-implemented method are received for assigning data points from first data to one of several objects, according to an example of the invention,

FIG. 4 shows schematically, projected data on the overlapping polygons shown in FIG. 3, and

FIGS. 5A and 5B shows schematically, a description of the process is used in assigning distance information to the respective groups of the method formed according to an example of the invention.

### DETAILED DESCRIPTION

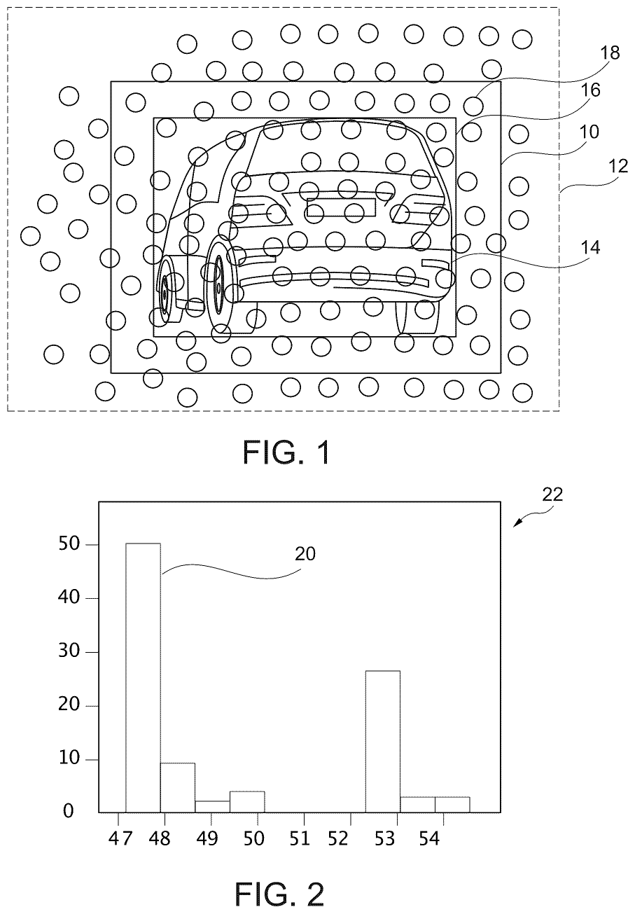

FIG. 1 schematically shows an exemplary step in a computer-implemented method for assigning data points from initial data to one of several objects at a time, according to an example of the invention.

In a first step in the method, information data is received from two-dimensional bounding polygons 10, 16, in this case from two-dimensional bounding rectangles 10, 16, for an object 14 shown on second data 12. As can be seen in FIG. 1, the second data 12 is image data 12, which has two spatial dimensions and was captured by a camera. In the present example, information data from a two-dimensional minimum bounding polygon 16 was first received. The minimum bounding polygon 16 was then scaled by a factor greater than 1, in this case by a factor of 1.25, to obtain the bounding polygon 10.

In the present case, the information data received from the polygon 10 define the size and position of the polygon 10 in the image data 12. Furthermore, a classification result of the object 16 shown on the image data 12 is received. In the present example, the object 16 shown on the image data 12 was assigned to the passenger car vehicle class.

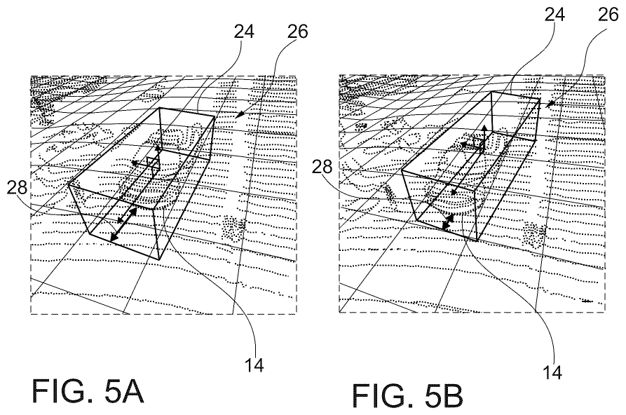

Furthermore, a projection matrix is received in the method, wherein the projection matrix defines a mapping of a three-dimensional data point from first data 26 (not shown in FIGS. 1 to 4, but in FIG. 5) onto a two-dimensional data point in the second data 12.

The first data 26 in the present case are lidar sensor data that are temporally correlated to the image data 12 captured by the camera. The lidar sensor data has three spatial dimensions. Using the projection matrix and the lidar sensor data, projected data points 18, which are shown in FIG. 1, can be generated in a further step of the method.

In a further step of the method, the projected data points 18 are divided into bins 20, based on the respective depth values of the original three-dimensional data points 26.

In the next step, groups of the projected data points 18 are formed, taking into account the received information data of the two-dimensional bounding polygons 10 and the bin 20 of the data point 18.

In a situation such as that shown in FIG. 1, where there are no overlapping polygons 10 of multiple objects 14, it is provided that the groups of projected data points 18 are formed by considering the frequency distribution 22 of the depth values for those projected data points 18 that are within a respective polygon 10, and that the respective polygon 10 is assigned the bin 20 which has a maximum in the frequency distribution 22 of the corresponding polygon 10. As shown in FIG. 2, figuratively speaking, a histogram 22 is formed with the projected data points 18, which are located within the polygon 10. In the present example, the polygon 10 is thus assigned the bin 20, which has a bin width of 47 meters to 48 meters.

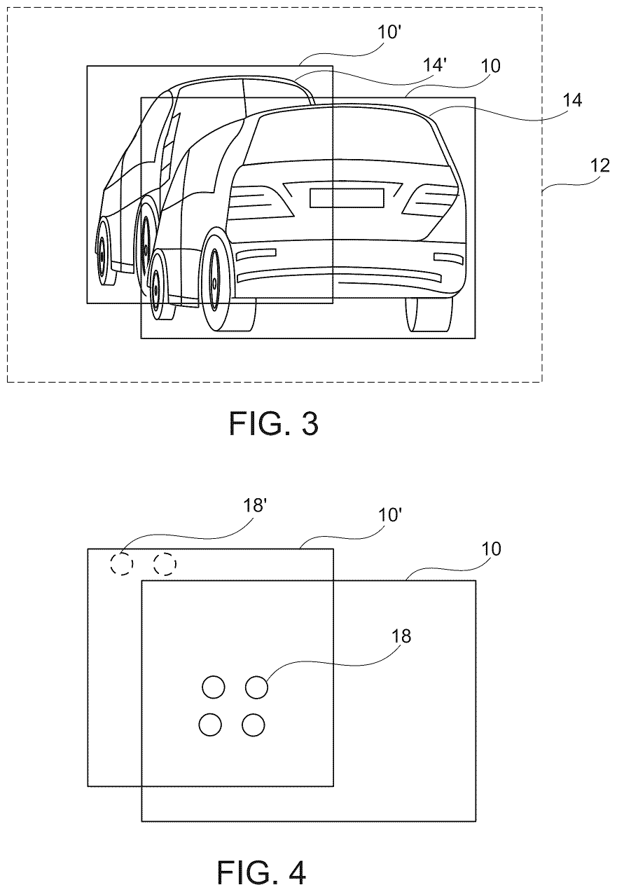

FIGS. 3 and 4 illustrate the procedure, 14, 14′ for several objects. As can be seen in FIG. 3, the image data 12 shows two objects 14 and 14′. The car 14 partially conceals the delivery van 14′. In addition, FIG. 3 shows the two-dimensional bounding polygons 10 and 10′ for the objects 14, 14′. In FIG. 3, the projected data points 18 are not drawn for the sake of clarity.

If in such a situation with overlapping polygons 10, 10′, the histogram 22 was created separately for each polygon 10, 10′ as in FIGS. 1 and 2, and then the maximum value of the frequency distribution 22 was assigned to the polygon 10, 10′, this would result in both polygons 10, 10′ being assigned the same bin 20, since the majority of the projected data points 18, 18′ that lie within the polygon 10′ stem from the object 14—the car—and not from the object 14′, the delivery van.

The method now provides that the groups of projected data points 18, 18′ are formed by means of an assignment method in such a way that in the case of overlapping polygons 10, 10′, in which data points 18, 18′ are located within more than one two-dimensional bounding polygon 10, 10′, the groups are formed in such a way that no bin 20, 20′ simultaneously contains more than one of the overlapping polygons 10, 10′. In the present case, the Hungarian method is used as an assignment method, which maximizes the number of projected data points 18, 18′ within a polygon 10 10′ when assigning.

As FIG. 4 illustrates, the assigning is done by combining the overlapping polygons 10, 10′ to form a total polygon. The groups of projected data points 18, 18′ are then formed by looking at the frequency distribution of the depth values for those projected data points 18, 18′ that are within the total polygon.

FIG. 4 illustrates this with two overlapping polygons 10, 10′ and two different bins 20, 20′ of the projected data points 18, 18′, wherein the projected data point 18 belongs to the bin 20 and the projected data point 18′ belongs to the bin 20′. The assignment problem, which is solved in the present case with the Hungarian method, can be represented by means of a matrix. The data of the assignment problem is collected in a quadratic matrix. Each row corresponds to a source—in this case a polygon 10, 10′, each column to a target—in this case a bin 20, 20′, and each matrix component contains the evaluation of the assignment—in this case, the number of projected data points 18, 18′.

For the assignment problem shown in FIG. 4, the following matrix results:

| | Bin 20 | Bin 20′ |
|---|---|---|
| Polygon 10 | 4 | 0 |
| Polygon 10′ | 4 | 2 |

An entry in this matrix at the point (row, column) counts how many points with a depth value which is covered by the bin 20, 20′ are in the polygon 10, 10′. Each polygon 10, 10′ is then assigned a bin 20, 20′ and each bin 20, 20′ can only be assigned once.

The goal is for the sum of the matrix entries corresponding to the assignment to be maximum. In this case, the bin 20 is assigned to the polygon 10 and the bin 20′ to the polygon 10′. The Hungarian method finds this optimal assignment. If the polygons 10, 10′ were to be considered individually, then both would be assigned the bin 20.

Those data points 18, 18′ that are within the bin 20, 20′ assigned to the polygon 10, 10′ then form the group of projected data points 18, 18′ assigned to the respective object.

In a further step of the method, exactly one piece of distance information is then assigned to the group. In the present example, this is done by averaging the respective depth values of the original three-dimensional data points 26 of the group assigned to the respective objects 14. In the present example, the assigned distance information is used in the following to determine a three-dimensional envelope 24 (see FIG. 5) for the object 14 shown on the first data 26.

In addition, as shown schematically in FIGS. 5A and 5B, a prior knowledge term dependent on the classification result of the object 14 is taken into account when assigning the distance information to the respectively formed groups. As schematically shown in FIG. 5A, objects 14 are only scanned by the sensor on surfaces that are aligned in the direction of the sensor due to their self-occlusion. In other words, data points from object 14 that are further away from the sensor are missing. If the distance information found on the basis of the described method is used for a focal point of the three-dimensional envelope 24, this can lead to a systematic error due to the “missing data points”. This systematic error is illustrated in FIG. 5A by the relatively large distance 28 between the front surface of the three-dimensional envelope 24 and the data points of the object 14. To compensate for this error, this example provides that the prior knowledge term is added to the distance information. As shown in FIG. 5B, this reduces the distance 28 between the front surface of the three-dimensional envelope 24 and the data points of the object 14.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for assigning data points from first data to one of several objects, wherein the first data comprises at least three spatial dimensions, the method comprising:
receiving information data from two-dimensional bounding polygons or from two-dimensional bounding rectangles for objects shown on second data, the second data comprising at least two spatial dimensions, the received information data defining a size and a position of the bounding polygon of the respective object in the second data;
receiving a projection matrix, the projection matrix defining a mapping of a three-dimensional data point of the first data to a two-dimensional data point in the second data;
generating projected data points by projecting the three-dimensional data points of the first data using the received projection matrix;
dividing the projected data points and/or the three-dimensional data points into bins based on a respective depth value of the three-dimensional data point; and
forming groups of projected data points assigned to the respective objects taking into account the received information data of the two-dimensional bounding polygons and the bin of the data point by an assignment method such that for overlapping polygons where projected data points are located within more than one two-dimensional bounding polygon, the groups are formed such that no bin is assigned to more than one of the overlapping polygons at the same time.

2. The method according to claim 1, wherein the first data is a point cloud captured by a lidar or radar sensor and/or the second data is image data captured by a camera.

3. The method according to claim 1, wherein the step of receiving information data of a two-dimensional bounding polygon comprises receiving information data of a two-dimensional minimum bounding polygon and/or of a two-dimensional minimum bounding rectangle, and scaling of the minimum bounding polygon by a factor greater than 1 and/or less than or equal to 1.5, and/or wherein the step of receiving information data of a two-dimensional bounding polygon comprises receiving information data of a two-dimensional minimum bounding polygon scaled by a factor greater than 1 and/or less than or equal to 1.5.

4. The method according to claim 1, wherein the step of dividing the projected data points and/or the three-dimensional data points into bins on the basis of the respective depth values of the three-dimensional data point, comprises a division of the projected data points and/or the three-dimensional data points into bins with the same bin width.

5. The method according to claim 1, wherein the step of forming groups of projected data points assigned to the respective objects is carried out taking into account the received information data of the two-dimensional bounding polygons and the bin of the data point via the Hungarian method.

6. The method according to claim 1, wherein the step of forming groups of projected data points assigned to the respective objects, taking into account the received information data of the two-dimensional bounding polygons and the bin of the data point, comprises the formation of groups in such a way that no projected data point is assigned to more than one group at the same time.

7. The method according to claim 1, wherein the method comprises the step of assigning a distance information or exactly one piece of distance information, to the respectively formed groups.

8. The method according to claim 7, wherein the step of assigning distance information to the respectively formed groups includes the formation of a mean value over the respective depth values of the three-dimensional data points of the group assigned to the respective objects.

9. The method according to claim 7, wherein the step of assigning distance information to the respectively formed groups includes adding a prior knowledge term dependent on a classification result of the object, and wherein the method comprises a step of receiving a classification result of the object.

10. The method according to claim 1, wherein the method comprises the step of determining a three-dimensional envelope or a cuboid for the objects represented on the first data, taking into account the formed groups or the assigned distance information, and the received information data of the two-dimensional bounding polygons.

11. The method according to claim 10, wherein the step of determining the three-dimensional envelope for the objects represented on the first data, taking into account the formed groups and the received information data of the two-dimensional bounding polygons, comprises a displacement and/or scaling of the three-dimensional envelope within a predefined limit such that the formed groups of three-dimensional data points are completely enclosed by the three-dimensional envelope.

12. A device for data processing to execute the method according to claim 1.

13. A computer program product comprising commands which, when the program is executed by a computer, cause the computer to execute the method according to claim 1.

14. A computer-readable medium on which the computer program product according to claim 13 is stored.
